(19) United States
(12) Patent Application Publication
(10) Pub. No.: US 2024/0337476 A1
(43) Pub. Date: Oct. 10, 2024

(54) ELECTROMAGNETIC WAVE FOCUSING FOR CONCENTRIC PIPE EVALUATION

(71) Applicants: SAUDI ARABIAN OIL COMPANY, Dhahran (SA); GOWELL INTERNATIONAL LLC, Houston, TX (US)

(72) Inventors: Mohamed Larbi Zeghlache, Al Khobar (SA); Qinshan Yang, Katy, TX (US)

(73) Assignees: SAUDI ARABIAN OIL COMPANY, Dhahran (SA); GOWELL INTERNATIONAL LLC, Houston, TX (US)

(21) Appl. No.: 18/622,692

(22) Filed: Mar. 29, 2024

Related U.S. Application Data
(60) Provisional application No. 63/494,789, filed on Apr. 7, 2023.

(51) Int. Cl. G01B 7/06; G01B 7/00

(52) U.S. Cl. CPC G01B 7/10; G01B 7/001

(57) ABSTRACT

A method for measuring a wall thickness of two concentric pipes includes launching a pipe inspection gauge (pig) within an inner pipe of the two concentric pipes; emitting, using an electromagnetic (EM) transmitter of the pig, magnetic fluxes toward one or more EM receivers of the pig; focusing, using one or more focusing devices, the emitted magnetic fluxes to compress and guide the emitted magnetic fluxes through the inner pipe toward the outer pipe and increase a signal to noise ratio of the one or more EM receivers; measuring, using the one or more EM receivers, the compressed and guided magnetic fluxes to generate a measured flux for providing to a pipe anomaly analyzer; and determining, using the pipe anomaly analyzer and based on the measured flux, the wall thickness of an outer pipe of the two concentric pipes.

### BACKGROUND

Oil and gas facilities require frequent inspection to ensure integrity of equipment structures, such as downhole tubing and other pipelines. The integrity of pipelines relates to pipe leaks, pipe weld defects, pipe failures, pipeline drag reduction, etc.

Magnetic flux measurement testing methods have been widely used and employed across many industries that require a non-contact and non-destructive evaluation of metallic objects. It is especially advantageous and plays an essential role in the oil and gas, subsea, downhole applications where multiple concentric pipes are located beneath the surface or under sea. The area is inaccessible to any other testing methods. In many instances, it is required to inspect and deliver thickness measurements of pipes to monitor their integrity. Such thickness measurements are critical for the overall reliability and performance. Concentric pipes integrity inspection is required to ensure that pipes are free of cracks and corrosion effects that may result in catastrophic consequences if left unmaintained.

In general, magnetic flux measurement technology employs a transducer that contains both the transmitter module which generates a strong initial magnetic field needed to magnetize surrounding ferromagnetic-metallic objects such as carbon-steel pipes and receiver that can measure flux density variations corresponding to pipe thickness changes. In a conventional form, magnetic flux measurement transducers face many challenges associated with multi-pipe thickness imaging measurements.

Tubing pipe withdrawal operation is very expensive, or impossible for some applications. A large amount of time and equipment (such as a rig) are needed, which significantly increases time required to complete pipe thickness measurement, analysis, and evaluation. Moreover, it results in an even higher cost increase of such an inspection due to a much longer suspension time of normal well production operations in addition to the cost of the tubing removal process itself. It is thus always desired that the inner tubing pipe remains in the well while measurement is performed in order to save time and to reduce cost of the tubular inspection. Such a solution is called through-tubing thickness evaluation where both inner tubing and outer casing pipes can be analyzed while the tubing pipe remains inside the casing in the borewell. The transducer module is then normally placed inside the inner pipe and can measure thickness of dual pipes. Solutions like ones employing electromagnetic omni-coil transducers can only provide average thickness due to their lack of finite azimuthal resolution and sensitivity to small thickness variations necessary to build imaging profile of pipes. The transducer needs to be positioned very close to the inner surface of the casing pipe during measurement in order to maintain a high enough signal-to-noise ratio to be able to deliver thickness imaging.

“Pipeline Pigging” refers to the practice of using devices or implements known as “pigs” (pipe inspection gauge) to perform various cleaning, clearing, maintenance, inspection, dimensioning, process, and pipeline testing operations on new and existing pipelines. For existing operational pipelines pigging is normally performed without stopping the flow of the product in the pipeline. The “pigs” can be of differing materials and configurations such Polyurethane Open Cell Foam, Cast Polyurethane, and Rubber.

### SUMMARY

In general, the invention solves the problem of measuring, logging, or inspecting the outer pipe thickness through the inner pipe. The existence of the inner pipe makes it impossible to use technologies that require direct contact to the outer pipe. For example, EM technology is unable to inspect the outer pipe while the tool is inside the pipe due to the shielding effect generated by the inner pipe. Embodiments of the invention relate to a magnetic flux transducer design and method that provide an ability to deliver high resolution thickness imaging for dual pipes while maintaining high signal-to-noise ratio (SNR) and sensitivity. For downhole and surface pipe's corrosion inspection using electromagnetic (EM) devices, Signal to Noise Ratio (SNR) and flux density ratio of (EM) measurement depends on many design parameters as well as the environmental factors. The larger and the more concentric pipes are there, the weaker is the signal. In order to improve the EM signal detection at the receivers, a novel solution is proposed using multiple configurations. EM focusing is designed to orient and focus the transmitted magnetic flux between transmitter(s) and receiver(s) and/or between receivers themselves. The resulted increase in signal strength improves the reliability and capabilities of existing EM measurement in multiple concentric pipe evaluation.

In one aspect, embodiments of the present disclosure relate to a method for measuring a wall thickness of two concentric pipes, comprising: launching a pipe inspection gauge (pig) within an inner pipe of the two concentric pipes; emitting, using an electromagnetic (EM) transmitter of the pig, magnetic fluxes toward one or more EM receivers of the pig; focusing, using one or more focusing devices, the emitted magnetic fluxes to compress and guide the emitted magnetic fluxes through the inner pipe toward the outer pipe and increase a signal to noise ratio of the one or more EM receivers; measuring, using the one or more EM receivers, the compressed and guided magnetic fluxes to generate a measured flux for providing to a pipe anomaly analyzer; and determining, using the pipe anomaly analyzer and based on the measured flux, the wall thickness of an outer pipe of the two concentric pipes.

In one aspect, embodiments of the present disclosure relate to a pipe inspection gauge (pig) for measuring a wall thickness of two concentric pipes, comprising: an electromagnetic (EM) transmitter configured to emit magnetic fluxes toward one or more EM receivers of the pig; one or more focusing devices configured to focus the emitted magnetic fluxes to compress and guide the emitted magnetic fluxes further toward the one or more EM receivers; and the one or more EM receivers configured to measure the compressed and guided magnetic fluxes to generate a measured flux for providing to a pipe anomaly analyzer, wherein said emitting, focusing, and measuring are in response to launching the pig within an inner pipe of the two concentric pipes, and wherein the pipe anomaly analyzer is configured to determine, based on the measured flux, the wall thickness of an outer pipe of the two concentric pipes.

In one aspect, embodiments of the present disclosure relate to a system for measuring a wall thickness of two concentric pipes, comprising: a pipe inspection gauge (pig) comprising: an electromagnetic (EM) transmitter configured to emit magnetic fluxes toward one or more EM receivers of the pig; one or more focusing devices configured to focus the emitted magnetic fluxes to compress and guide the emitted magnetic fluxes further toward the one or more EM receivers; and the one or more EM receivers configured to measure the compressed and guided magnetic fluxes to generate a measured flux for providing to a pipe anomaly analyzer; a pig launching station configured to launch the pig within an inner pipe of the two concentric pipes, wherein said emitting, focusing, and measuring are in response to said launching the pig; and a pipe anomaly analyzer configured to determine, based on the measured flux, the wall thickness of an outer pipe of the two concentric pipes.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A-1D show a system in accordance with one or more embodiments.

FIGS. 2A-3C show various configurations of the system in accordance with one or more embodiments.

FIG. 4 shows a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (for example, first, second, third) may be used as an adjective for an element (that is, any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include a method and system for performing a maintenance operation of an equipment structure using a smart pipe inspection gauge (pig) that provides an ability to deliver high resolution thickness imaging for dual pipes while maintaining high signal-to-noise ratio (SNR) and sensitivity.

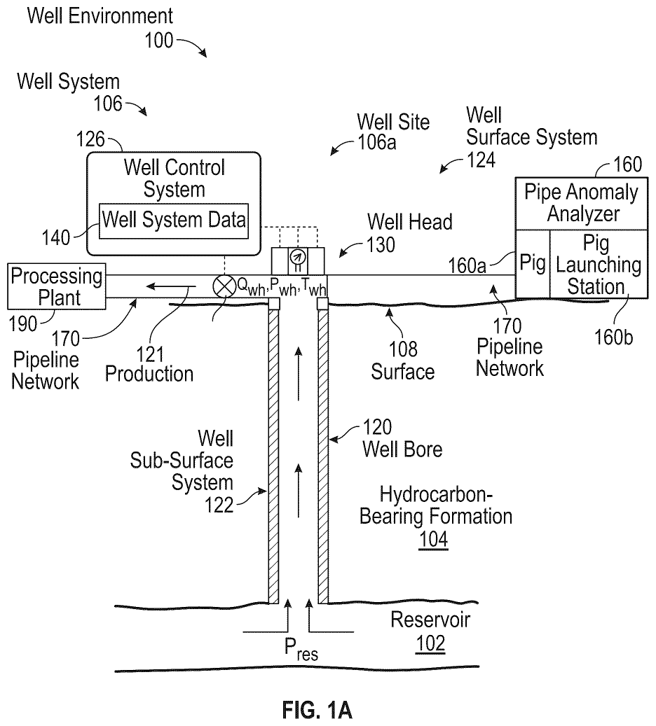

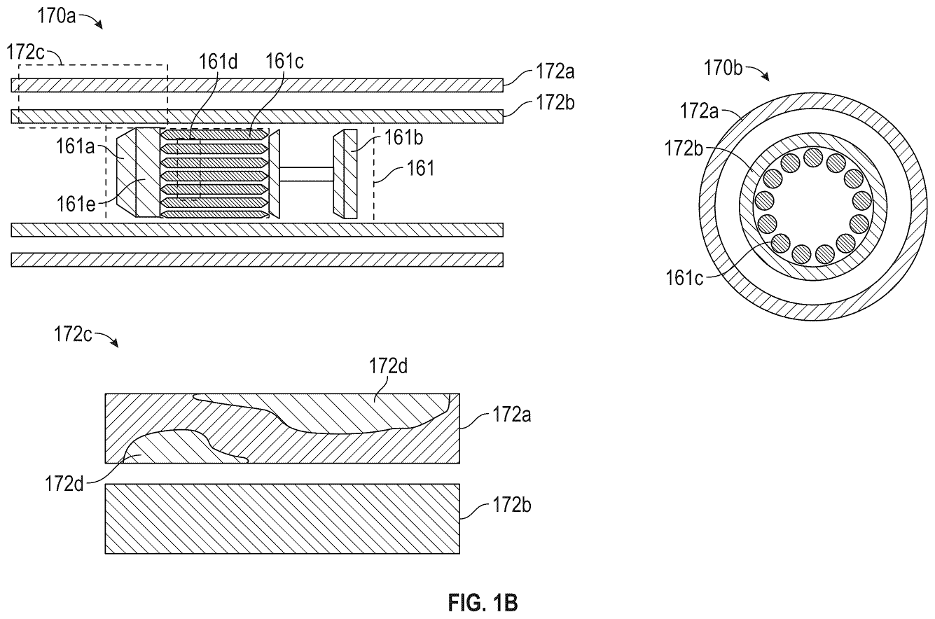

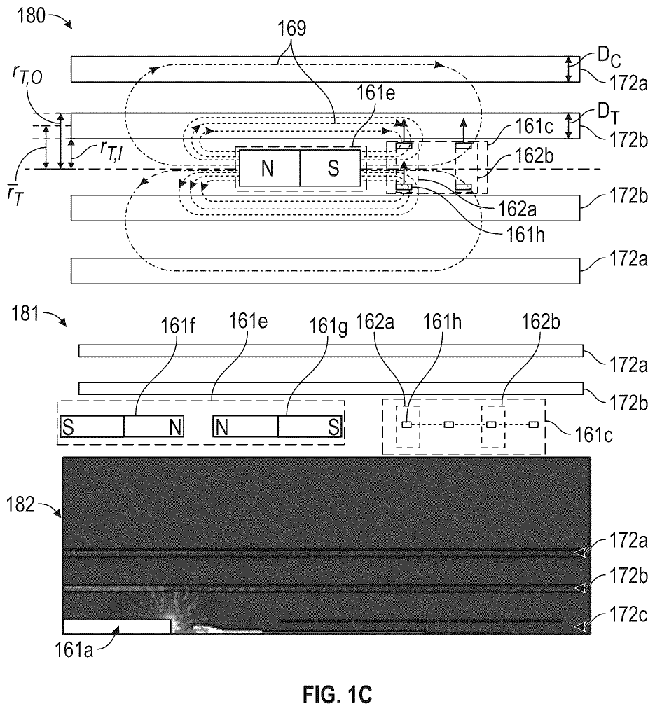

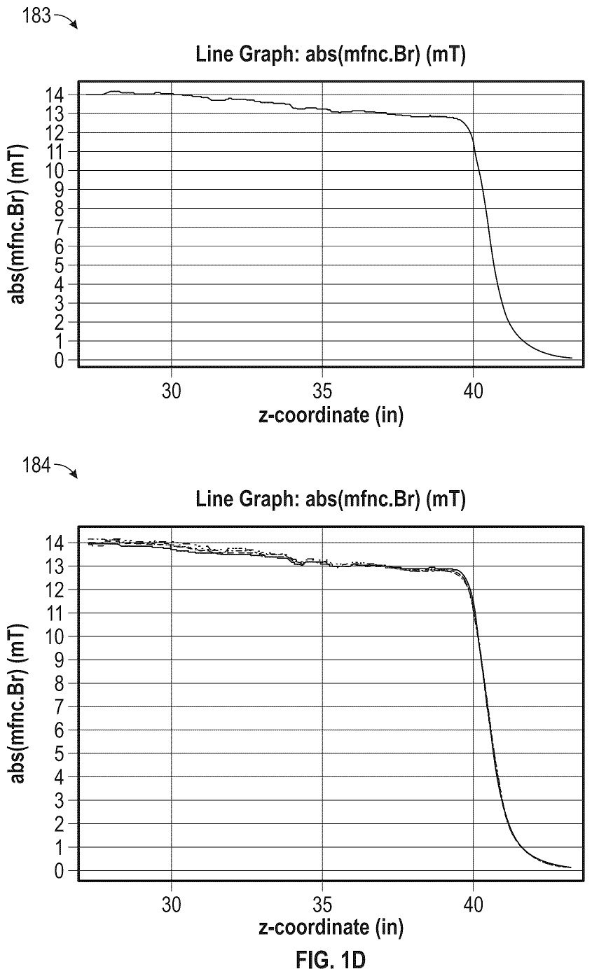

Turning to FIG. 1A, FIG. 1A shows a schematic diagram of an oil and gas facility in accordance with one or more embodiments. As shown in FIG. 1A, FIG. 1A illustrates a well environment (100) that includes a hydrocarbon reservoir (“reservoir”) (102) located in a subsurface hydrocarbon-bearing formation (“formation”) (104) and a well system (106). The area where the well system (106) is located is referred to as a wellsite (106a). The hydrocarbon-bearing formation (104) may include a porous or fractured rock formation that resides underground, beneath the earth's surface (“surface”) (108). In the case of the well system (106) being a hydrocarbon well, the reservoir (102) may include a portion of the hydrocarbon-bearing formation (104). The hydrocarbon-bearing formation (104) and the reservoir (102) may include different layers of rock having varying characteristics, such as varying degrees of permeability, porosity, capillary pressure, and resistivity. In the case of the well system (106) being operated as a production well, the well system (106) may facilitate the extraction of hydrocarbons (or “production”) from the reservoir (102). The well system (106) may be part of a production system that further includes a pipeline network (170) and a processing plant (190) for transporting and processing the hydrocarbons, i.e., production from the reservoir (102).

In some embodiments, the well system (106) includes a wellbore (120), a well sub-surface system (122), a well surface system (124), and a well control system (“control system”) (126). The control system (126) may control various operations of the well system (106), such as well production operations, well completion operations, well maintenance operations, and reservoir monitoring, assessment and development operations. In some embodiments, the control system (126) includes a computer system.

The wellbore (120) may include a bored hole that extends from the surface (108) into a target zone of the hydrocarbon-bearing formation (104), such as the reservoir (102). An upper end of the wellbore (120), terminating at or near the surface (108), may be referred to as the “up-hole” end of the wellbore (120), and a lower end of the wellbore, terminating in the hydrocarbon-bearing formation (104), may be referred to as the “down-hole” end of the wellbore (120). The wellbore (120) may facilitate the circulation of drilling fluids during drilling operations, the flow of hydrocarbon production (“production”) (121) (e.g., oil and gas) from the reservoir (102) to the surface (108) during production operations, the injection of substances (e.g., water) into the hydrocarbon-bearing formation (104) or the reservoir (102) during injection operations, or the communication of monitoring devices (e.g., logging tools) into the hydrocarbon-bearing formation (104) or the reservoir (102) during monitoring operations (e.g., during in situ logging operations).

In some embodiments, the well sub-surface system (122) includes casing installed in the wellbore (120). For example, the wellbore (120) may have a cased portion and an uncased (or “open-hole”) portion. The cased portion may include a portion of the wellbore having casing (e.g., casing pipe and casing cement) disposed therein.

In some embodiments, the well surface system (124) includes a wellhead (130). The wellhead (130) may include a rigid structure installed at the “up-hole” end of the wellbore (120), at or near where the wellbore (120) terminates at the Earth's surface (108). The wellhead (130) may include structures for supporting (or “hanging”) casing and production tubing extending into the wellbore (120). Production (121) may flow through the wellhead (130), after exiting the wellbore (120) and the well sub-surface system (122), including, for example, the casing and the production tubing.

In some embodiments, during operation of the well system (106), the control system (126) collects and records well system data (140) for the well system (106). The well system data (140) may include, for example, a record of measurements of wellhead pressure (P_{wh}) (e.g., including flowing wellhead pressure), wellhead temperature (T_{wh}) (e.g., including flowing wellhead temperature), wellhead production rate (Q_{wh}) over some or all of the life of the well system (106), and water cut data. The well system data (140) may further include pipeline monitoring data of equipment structures at the wellsite (106a) (e.g., downhole tubing) and/or throughout the pipeline network (170). Throughout this disclosure, the term “equipment structure” refers to mechanical structures of equipment and piping network. In some embodiments, the measurements and monitoring data are recorded in real-time, and are available for review or use within seconds, minutes or hours of the condition being sensed (e.g., the measurements are available within 1 hour of the condition being sensed). In such an embodiment, the well system data (140) may be referred to as “real-time” well system data (140). Real-time well system data (140) may enable an operator of the well (106) to assess a relatively current state of the well system (106), and make real-time decisions regarding development and maintenance of the well system (106) and the reservoir (102), such as on-demand adjustments in regulation of production flow from the well or preventive maintenance of equipment structures to prevent disruption to the production flow from the well.

Smart pigs or Pipeline Inspection Gauges (pigs) are large pieces of machinery to facilitate the maintenance of transmission pipelines. These pipeline pigging devices are major components to pipeline safety and accident prevention. These inspection tools provide data on the condition of pipelines which help gauge the health and integrity of the pipes. In addition, these smart pipeline pigs make sure that transmission of the product does not stop due to pipeline integrity issues, which can be disastrous to the bottom line.

What makes intelligent pigging different is that smart pigs are capable of performing advanced inspection activities as they travel along the pipe, in addition to just cleaning it. Smart pigs use nondestructive examination techniques such as ultrasonic testing and magnetic flux leakage testing to inspect for erosion corrosion, metal loss, pitting, weld anomalies, and hydrogen induced cracking, among others. They are also able to gather data on the pipeline's diameter, curvature, bends, and temperature.

Smart pigging provides a number of advantages over traditional forms of pipeline inspection. It allows pipelines to be cleaned and inspected without having to stop the flow of product. It also allows a pipeline to be completely inspected without having to send inspectors down its entire length. Finally, it provides cleaning and inspection services at the same time, saving companies both time and money.

In some embodiments, the well system (106) includes a pipeline inspection gauge (pig) (160a) with an associated pig launching station (160b) and a pipe anomaly analyzer (160) for generating and analyzing pipeline monitoring data. For example, the quality of pipelines may be monitored and analyzed over a time period, or the deterioration of a pipe may be identified over time to enable proactive maintenance or repair.

By inserting the pig (160a) into the pig launching station (160b) and then applying flow under pressure to the rear of the pig (160a), the pig (160a) will move into and through the pipeline network (170). The force applied by the pig (160a) as it traverses the pipeline network (170) can be calculated by multiplying the cross-sectional area of the back of the pig (160a) by the pressure applied to the rear of the pig (160a). Once the pig (160a) has launched and is moving through the pipeline network (170), the differential pressure can be calculated by subtracting the pressure in front of the pig (160a) from the pressure acting on the back of the pig (160a). The pig speed can be calculated by tracking the pig (160a) at various points along the pipeline network (170) and calculating the time it takes to arrive at each point against the input pressure and flow rate and then converting to velocity.

In some embodiments, the pipe anomaly analyzer (160) may include hardware and/or software with functionality for facilitating maintenance operations of the well system (106). For example, the pipe anomaly analyzer (160) may store a portion of the well system data (140) such as pipeline monitoring data. In some embodiments, the pipe anomaly analyzer (160) may analyze the pipeline monitoring data to generate recommendations to facilitate various maintenance operations of the well system (106), such as a preventive maintenance of the equipment structures. In some embodiments, the pipe anomaly analyzer (160) may include hardware and/or software with functionality for receiving or retrieving the pipeline monitoring data from the pig (160a) for analysis. In addition, the pipe anomaly analyzer (160) generates maintenance recommendations based on an analysis result of the pipeline monitoring data received or retrieved from the pig (160a).

While the pipeline monitoring data is described above for equipment structures installed in the well system (106) and/or the pipeline network (170), alternative monitoring data may correspond to equipment structures installed in the processing plant (190). In one or more embodiments, the processing plant (190) is an industrial process plant such as an oil/petroleum refinery where petroleum (crude oil) is transformed and refined, or other types of chemical processing plants. The processing plant (190) typically includes large, sprawling industrial complexes with extensive piping network running throughout, carrying streams or liquids between large chemical processing units, such as distillation columns. Processing plant facilities require frequent inspection in order to ensure the asset integrity of the structure and safe work practices.

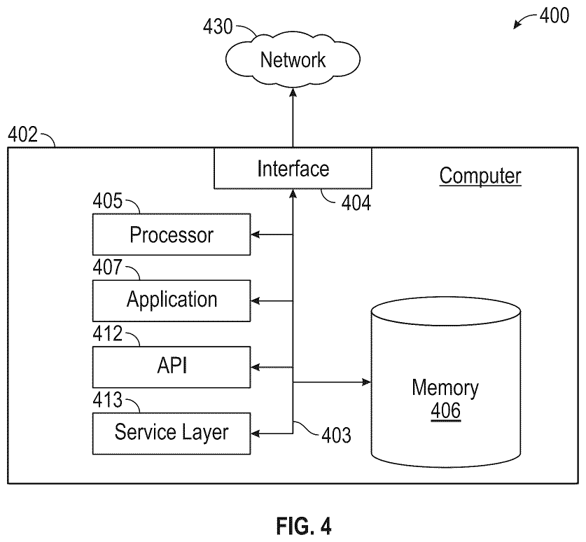

While the pipe anomaly analyzer (160) is shown at a well site, embodiments are contemplated where at least a portion of the pipe anomaly analyzer (160) is located away from well sites. In some embodiments, the pipe anomaly analyzer (160) may include a computer system that is similar to the computing system (400) described below with regard to FIG. 4 and the accompanying description.

Turning to FIG. 1B, FIG. 1B illustrates an example schematic diagram of a pipe inspection gauge (pig) for inspecting the pipelines depicted in FIG. 1A above. In particular, FIG. 1B shows a longitudinal cross-sectional view (170a) and a transversal cross-sectional view (170b) of a dual pipe configuration. In one or more embodiments, one or more of the modules and/or elements shown in FIG. 1B may be omitted, repeated, combined and/or substituted. Accordingly, embodiments disclosed herein should not be considered limited to the specific arrangements of modules and/or elements shown in FIG. 1B.

As shown in FIG. 1B, an electrical magnetic pig (EM pig) (161) is disposed inside the dual pipe configuration of an outer pipe (172a) and an inner pipe (172b). A portion (172c) of the dual pipe configuration is expanded to illustrate anomalies (172d) in the outer pipe (172a). For example, the anomalies (172d) may include corrosions that reduced the thickness of the outer pipe (172a). The EM pig (161) includes an array of EM receivers (161c) and one or more focusing devices (161d) disposed between a head portion (161a) and a tail portion (161b). An EM transmitter (161e) is disposed in the head portion (161a). In one or more embodiments, as shown in the transversal cross-sectional view (170b), the array of EM receivers (161c) is formed by receiver elements arranged in a ring configuration adjacent to the inside surface of the inner pipe (172b). In some embodiments, the EM receivers (161c) generate pipeline monitoring data based on measurements of the received magnetic flux (169). The pipeline monitoring data may be stored in a local data storage of the pig (161) for later retrieval by the pipe anomaly analyzer (160). Alternatively, the pipeline monitoring data may be transmitted by a wireless data transmitter of the pig (161) to the pipe anomaly analyzer (160).

FIG. 1C illustrates basic EM measurement in the dual pipe configuration depicted in FIG. 1B above. The focusing device (161d) is omitted in FIG. 1C to illustrate a baseline configuration. As shown in the diagram (180) of FIG. 1C, the EM transmitter (161e) generates magnetic field fluxes through the outer pipe (172a) and inner pipe (172b) that are represented as dashed lines. The array of EM receivers (161c) includes a series of receiver element rings (e.g., 162a, 162b) disposed along the longitudinal direction of the concentric outer pipe (172a) and inner pipe (172b). Each receiver element ring includes a ring of receiver elements (161h) disposed in a transversal cross sectional plane of the concentric outer pipe (172a) and inner pipe (172b).

The diagram (181) corresponds to the top half of the diagram (180) and illustrates a variation of the EM transmitter (161e) and the array of EM receivers (161c). In particular, the EM transmitter (161e) includes two N-S transmitters (161f, 161g) where the two N-sides of the N-S transmitters (161f, 161g) are disposed next to each other. In this configuration, the magnetic field of the N-S transmitter (161f) pushes the magnetic field of the N-S transmitter (161g) to increase magnetic flux toward the array of EM receivers (161c), which includes four receiver element rings.

The diagram (182) illustrates the magnetic flux profile of the outer pipe (172a), the inner pipe (172b), and the longitudinal axis (172e) as distance increases form the EM transmitter (161e). Specifically, the magnetic flux depicted within the wall thickness of the outer pipe (172a) is referred to as the casing flux Φ_{c}, the magnetic flux depicted within the wall thickness of the inner pipe (172b) is referred to as the tubing flux Φ_{T}, and the magnetic flux depicted along the longitudinal axis (172e) is measured using the EM receiver element rings (162a, 162b, etc.) and referred to as the measured flux. Correspondingly in FIG. 1D, the plot (183) shows the EM flux average density profile along the longitudinal axis (i.e., Z-coordinate) of the concentric pipes. The plot (184) shows the EM flux average density quadratic profiles along the longitudinal axis (i.e., Z-coordinate) of the concentric pipes.

The measurement sensitivity to the outer pipe (172a) refers to how sensitive the measured flux is with respect to the casing flux Φ_{c}. The measurement sensitivity to the outer pipe (172a) depends on many parameters and mostly affected by the flux density ratio r_{flux} which is defined by casing flux Φ_{c} of the outer pipe (172a) divided by the tubing flux Φ_{T} of the inner pipe (172b).

$${r}_{flux} = \frac{{Φ}_{c}}{{Φ}_{T}} .$$

The flux density ratio r_{flux} represents how much energy in forced through the inner pipe (172b) to reach the outer pipe (172a). A higher flux density ratio in the outer pipe area makes the measurement more sensitive to the outer pipe information. The higher r_{flux} is the better for the design of the EM pig (161) to improve the measurement of the outer pipe (172a).

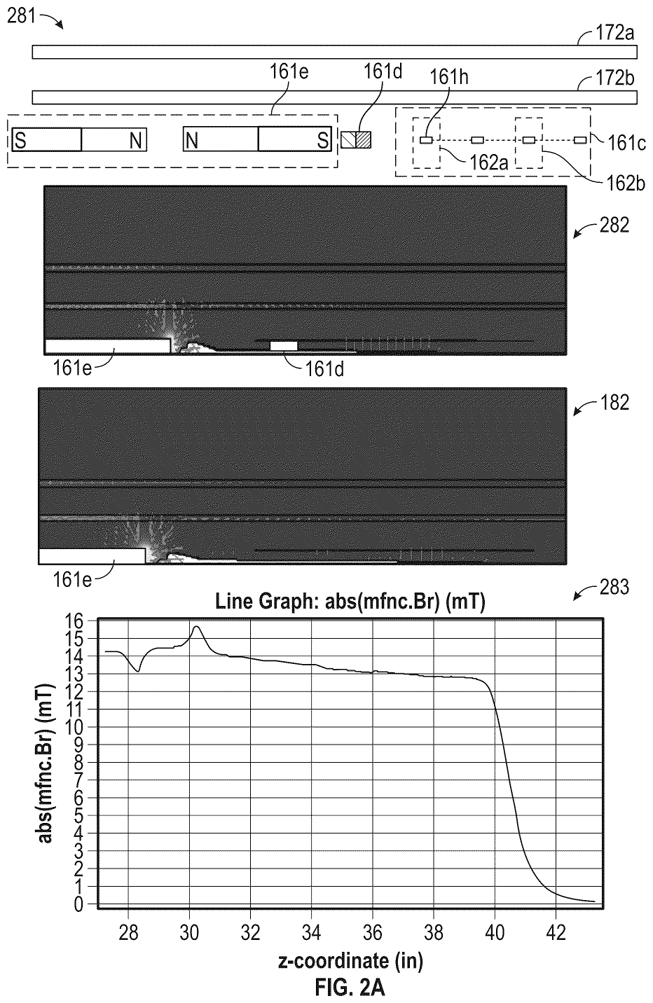

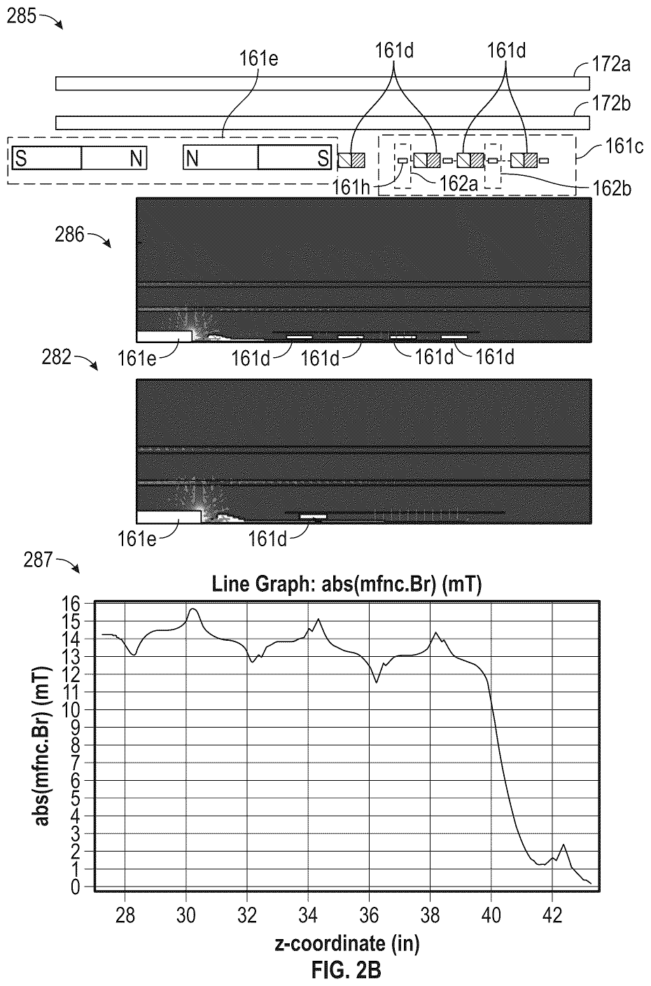

FIG. 2A illustrates an improved EM measurement in the dual pipe configuration depicted in FIG. 1B above. A shown in FIG. 2A, the diagram (281) corresponds to the diagram (181) depicted in FIG. 1C above with an additional focusing device (161d) disposed between the EM transmitter (161e) and the array of EM receivers (161c). Accordingly, the magnetic fluxes in between the EM transmitter (161e) and the array of EM receivers (161c) are focused, compressed, and guided toward the EM receivers (161c). The in-line position, size, length, strength, and EM proprieties of the focusing device (161d) may be adjusted based on the required configuration and environment (e.g., size of the concentric pipes). The focusing device (161d) may include a DC coil that provides a constant EM field. Other alternatives of the DC coil with or without variable and controllable EM field strength may be added to the focusing device (161d). For example, the focusing device (161d) may be a single electromagnet, a permanent magnet, etc. with or without shielding material. In some embodiments, the focusing device (161d) may include multiple electromagnets and/or permanent magnets that are configured in an azimuthal array, such as a ring configuration adjacent to the inside wall of the inner pipe (172b).

The diagram (282) illustrates the magnetic flux profile of the outer pipe (172a), the inner pipe (172b), and the longitudinal axis (172e) with the focusing device (161d) as distance increases form the EM transmitter (161e). The diagram (182) depicted in FIG. 1C above is copied here for comparison to the diagram (282). As noted above, the magnetic flux depicted within the wall thickness of the outer pipe (172a) is referred to as the casing flux Φ_{c}, the magnetic flux depicted within the wall thickness of the inner pipe (172b) is referred to as the tubing flux Φ_{T}, and the magnetic flux depicted along the longitudinal axis (172e) is measured using the EM receiver element rings (162a, 162b, etc.) and referred to as the measured flux. Correspondingly, the plot (283) shows the EM flux average density profile along the longitudinal axis (i.e., Z-coordinate) of the concentric pipes.

In this configuration, flux density increases more than 1.7 mT or 13%. This will lead into a more sensitive measurement close to the focusing device (161d). This will mostly improve the signal-to-noise ratio (SNR) for the inner pipe evaluation.

FIG. 2B illustrates another improved EM measurement in the dual pipe configuration depicted in FIG. 1B above. As shown in FIG. 2B, the diagram (285) corresponds to the diagram (281) depicted in FIG. 2A above with additional focusing devices (161d) disposed between each EM receiver element ring (e.g., 162a, 162b, etc.) in the array of EM receivers (161c). The additional focusing devices (161d) improve the return flux to the EM receivers (161c) especially for the far receiver element rings, i.e., the receiver element rings farther away from the EM transmitter (161e).

Similar to the configuration depicted in FIG. 2A above, the magnetic fluxes in between the EM transmitter (161e) and the array of EM receivers (161c) are focused, compressed, and guided toward the EM receivers (161c). The in-line position, size, length, strength, and EM proprieties of the focusing device (161d) may be adjusted based on the required configuration and environment (e.g., size of the concentric pipes). The focusing device (161d) may include a DC coil that provides a constant EM field. Other alternatives of the DC coil with or without variable and controllable EM field strength may be added to the focusing device (161d). For example, the focusing device (161d) may be a single electromagnet, a permanent magnet, etc. with or without shielding material. In some embodiments, the focusing device (161d) may include multiple electromagnets and/or permanent magnets that are configured in an azimuthal array, such as a ring configuration adjacent to the inside wall of the inner pipe (172b).

The diagram (286) illustrates the magnetic flux profile of the outer pipe (172a), the inner pipe (172b), and the longitudinal axis (172e) with the focusing device (161d) as distance increases form the EM transmitter (161e). The diagram (282) depicted in FIG. 2A above is copied here for comparison to the diagram (286). As noted above, the magnetic flux depicted within the wall thickness of the outer pipe (172a) is referred to as the casing flux Φ_{c}, the magnetic flux depicted within the wall thickness of the inner pipe (172b) is referred to as the tubing flux Φ_{T}, and the magnetic flux depicted along the longitudinal axis (172e) is measured using the EM receiver element rings (162a, 162b, etc.) and referred to as the measured flux. Correspondingly, the plot (287) shows the EM flux average density profile along the longitudinal axis (i.e., Z-coordinate) of the concentric pipes.

In this configuration, the flux density increases approximately 15% near each EM receiver element ring including the far ones, thus leading to a more sensitive measurement and most importantly improve SNR for the outer pipe evaluation.

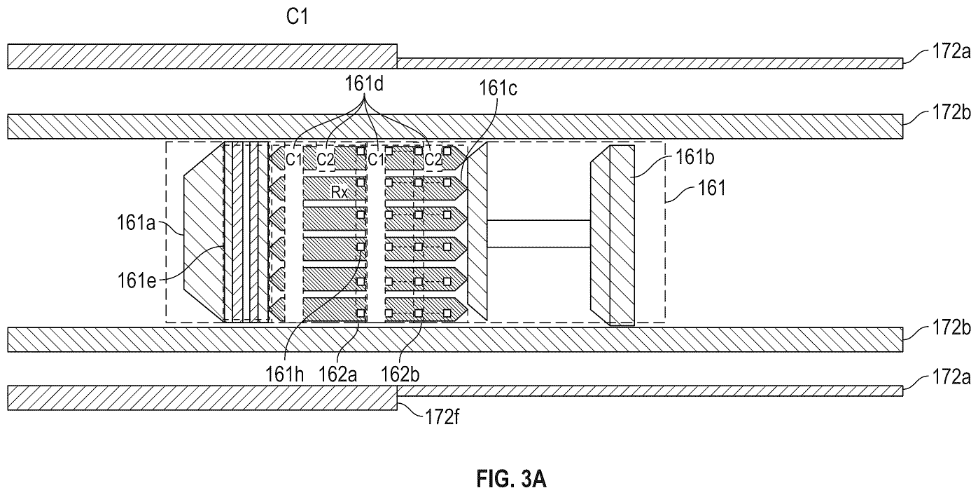

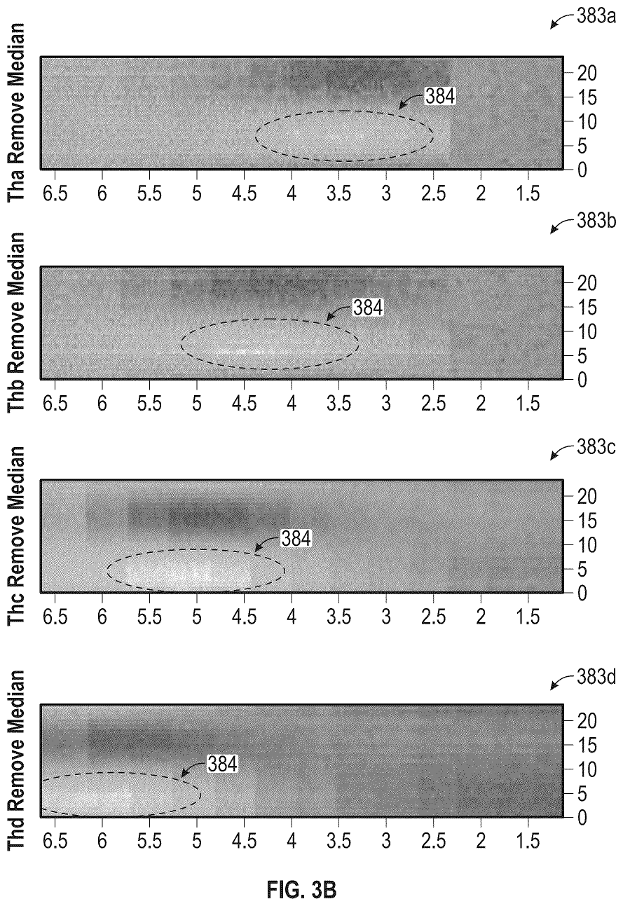

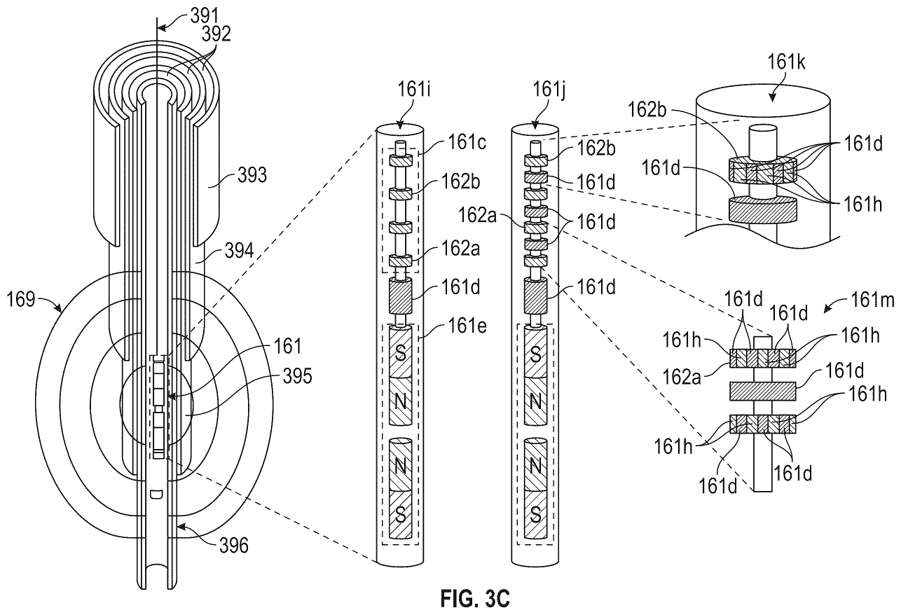

FIG. 3A illustrates yet another improved EM measurement in the dual pipe configuration depicted in FIG. 1B above. As shown in FIG. 3A, the configuration of the EM pig (161) corresponds to the diagram (285) depicted in FIG. 2B above with a combination of two sets of focusing devices (161d) disposed between the EM transmitter (161e) and each EM receiver element ring (162a, 162b, etc.) in the array of EM receivers (161c). As noted above, each receiver element ring includes a ring of receiver elements (161h) disposed in a transversal cross sectional plane of the concentric outer pipe (172a) and inner pipe (172b).

The first set of the focusing devices (161d) is denoted as C1 and form a ring configuration depicted in the transversal cross-sectional view (170b) of FIG. 1B above. The first set of the focusing devices (161d) is mounted separate from the array of EM receivers (161c). The second set of the focusing devices (161d) is denoted as C2 where each focusing device (161d) is mounted on an individual EM receiver (161c) in-between adjacent EM receiver element ring (e.g., 162a, 162b, etc.). While two sets of focusing devices (161d) are shown in FIG. 3A, in some embodiments, the first set or the second set of the focusing devices (161d) (i.e., C1 or C2) may be omitted.

Similar to the configurations depicted in FIGS. 2A and 2B above, the focusing device (161d) may include a DC coil that provides a constant EM field. Other alternatives of the DC coil with or without variable and controllable EM field strength may be added to the focusing device (161d). For example, the focusing device (161d) may be a single electromagnet, a permanent magnet, etc. with or without shielding material. In some embodiments, the focusing device (161d) may include multiple electromagnets and/or permanent magnets that are configured in an azimuthal array, such as a ring configuration adjacent to the inside wall of the inner pipe (172b).

Further as shown in FIG. 3A, the wall thickness of the outer pipe (172a) includes a step change (172f). Correspondingly in FIG. 3B, the diagrams (383a, 383b, 383c, 383d) illustrate the magnetic flux profile along the longitudinal axis (172e) (i.e., measured flux) while the EM pig (161) moves inside the inner pipe (172b) passing the step change (172f) of the wall thickness of the outer pipe (172a). In each of the diagrams (383a) through (383d), the highlighted area (384) corresponds to the range of high measurement sensitivity to the outer pipe (172a).

The EM focusing for multiple concentric pipe inspection shown in FIGS. 1C, 2A, 2B, and 3A is also used for downhole well evaluation as depicted in FIG. 3C. In this application, the pig (161) is integrated in a logging tool that runs inside the wellbore using any conveyance method in real-time acquisition mode or local memory storage mode. For example, the logging tool may be suspended in the wellbore via the wireline (391), slickline (391), coil-tubing (391), etc. In particular, the casings (392, 393, 394, 395, 396) form the multiple concentric pipes penetrated by the magnetic fluxes (169). In this example configuration, the pig (161) is launched into the multiple concentric pipes by lowering the logging tool into the wellbore, such as the wellbore (120) depicted in FIG. 1A above.

An example of the pig (161) is shown in an expanded view (161i) that corresponds to the diagram (281) depicted in FIG. 2A above where the focusing device (161d) is disposed between the transmitter (161e) and the array of EM receivers (161c). Another example of the pig (161) is shown in an expanded view (161j) that corresponds to the diagram (285) depicted in FIG. 2B above where multiple focusing devices (161d) are disposed between the transmitter (161e) and adjacent receiver element rings (162a, 162b, etc.). A portion of the pig (161) in the expanded view (161j) is shown in further detail in an expanded view (161k) where multiple focusing devices (161d) are disposed between adjacent receiver elements (161h) in the receiver element ring (162b). Similarly, another portion of the pig (161) in the expanded view (161j) is shown in further detail in an expanded view (161m) where multiple focusing devices (161d) are disposed between adjacent receiver elements (161h) in the receiver element ring (162a) and a lower receiver element ring.

By offsetting the focusing devices (161d) and receiver elements (161h) in each or some receiver element ring (e.g., receiver element ring (162b)), the azimuthal resolution of the pipe inspection tool can be further improved. As shown in the expanded view (161m), the receiver element ring (162a) contains 4 receiver elements that are 90 degrees apart and in-between there are 4 focusing devices. The receiver element ring (162a) in conjunction with the lower receiver element ring having the same construction but rotated 45 degrees results in an effective azimuthal resolution of 45 degrees. Specifically, two receiver element rings each with 90 degrees resolution results in the improved resolution of 45 degrees. Further, the effective azimuthal resolution can be as low as 360 degrees divided by the total number of receiver elements in all receiver element rings. This helps in solving problems related to required space to include more receiver elements and focusing devices for higher resolution tools.

Accordingly, the expanded views (161i, 161j, 161k, 161m) illustrate the flexible configurations of the logging/inspection tool with respect to type, size, position, orientation, number and EM properties of the focusing device.

Embodiments may be implemented on a computer system. FIG. 4 is a block diagram of a computer system (400) used to provide computational functionalities associated with described algorithms, methods, functions, processes, flows, and procedures as described in the instant disclosure, according to an implementation. The illustrated computer (402) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402). The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or other suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the instant disclosure.

The computer (402) also includes a memory (406) that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), each computer (402) communicating over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

In some embodiments, the computer (402) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service ANN models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Embodiments provide the following advantages: (i) improved accuracy in that the techniques can be trained on high-quality and relevant data, leading to improved accuracy in detecting leaks, classifying defects, and predicting failures, (ii) real-time processing in that by optimizing the algorithms, real-time processing and decision-making can be achieved, allowing for quicker actions in the event of a leak or failure, (iii) early detection in that the ANN models can be trained to identify early signs of leaks, defects, and failures, allowing for proactive maintenance and mitigation, (iv) cost savings in that by detecting leaks, classifying defects, and predicting failures early, significant cost savings can be achieved in terms of repairs, replacements, and environmental clean-up, (v) improved safety in that by detecting and mitigating potential failures early, the safety of pipeline operations and the surrounding communities can be improved, (vi) enhanced data integration in that the algorithms can be integrated more effectively with existing pipeline management systems, allowing for seamless data exchange and decision-making, and customization in that the ANN models can be made more adaptable to different pipeline systems by incorporating more diverse data sources and allowing for greater customization of the ANN models.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A device for measuring a wall thickness of two concentric pipes, comprising:
an electromagnetic (EM) transmitter configured to emit magnetic fluxes toward one or more EM receivers;
one or more focusing devices configured to focus the emitted magnetic fluxes to compress and guide the emitted magnetic fluxes further toward the one or more EM receivers; and
the one or more EM receivers configured to measure the compressed and guided magnetic fluxes to generate a measured flux for providing to a pipe anomaly analyzer,
wherein said emitting, focusing, and measuring are in response to launching the device within an inner pipe of the two concentric pipes, and
wherein the pipe anomaly analyzer is configured to determine, based on the measured flux, the wall thickness of an outer pipe of the two concentric pipes.

2. The device of claim 1,
wherein the one or more focusing devices comprise one or more of a magnet, an electrical coil, and ferromagnetic material.

3. The device of claim 1,
wherein the one or more focusing devices comprise a first focusing device disposed between the EM transmitter and the one or more EM receivers along a longitudinal direction of the two concentric pipes.

4. The device of claim 3,
wherein the one or more EM receivers comprise a sequential array of receiver element rings along the longitudinal direction of the two concentric pipes, each receiver element ring in the sequential array comprising receiver elements arranged in a ring configuration adjacent to an inside surface of the inner pipe, and
wherein each pair of adjacent receiver element rings within the sequential array is associated with one of the one or more focusing devices that is disposed between said pair of adjacent receiver element rings along the longitudinal direction of the two concentric pipes.

5. The device of claim 3,
wherein the one or more EM receivers form a sequential array of receiver element rings along the longitudinal direction of the two concentric pipes, each receiver element ring in the sequential array comprising receiver elements arranged in a ring configuration adjacent to an inside surface of the inner pipe, and
wherein each pair of adjacent receiver elements in at least one receiver element ring in the sequential array is associated with one of the one or more focusing devices that is disposed between said pair of adjacent receiver elements along a circumferential direction of said at least one receiver element ring.

6. The device of claim 1,
wherein the two concentric pipes are part of a pipeline network.

7. The device of claim 1,
wherein the device is embedded in a downhole logging tool, and
wherein the two concentric pipes are part of a wellbore casing.

8. A system for measuring a wall thickness of two concentric pipes, comprising:
a device comprising:
an electromagnetic (EM) transmitter configured to emit magnetic fluxes toward one or more EM receivers;
one or more focusing devices configured to focus the emitted magnetic fluxes to compress and guide the emitted magnetic fluxes further toward the one or more EM receivers; and
the one or more EM receivers configured to measure the compressed and guided magnetic fluxes to generate a measured flux for providing to a pipe anomaly analyzer;
a launching station configured to launch the device within an inner pipe of the two concentric pipes, wherein said emitting, focusing, and measuring are in response to said launching the device; and
a pipe anomaly analyzer configured to determine, based on the measured flux, the wall thickness of an outer pipe of the two concentric pipes.

9. The system of claim 8,
wherein the one or more focusing devices comprise one or more of a magnet, an electrical coil, and ferromagnetic material.

10. The system of claim 8,
wherein the one or more focusing devices comprise a first focusing device disposed between the EM transmitter and the one or more EM receivers along a longitudinal direction of the two concentric pipes.

11. The system of claim 10,
wherein the one or more EM receivers comprise a sequential array of receiver element rings along the longitudinal direction of the two concentric pipes, each receiver element ring in the sequential array comprising receiver elements arranged in a ring configuration adjacent to an inside surface of the inner pipe, and
wherein each pair of adjacent receiver element rings within the sequential array is associated with one of the one or more focusing devices that is disposed between said pair of adjacent receiver element rings along the longitudinal direction of the two concentric pipes.

12. The system of claim 10,
wherein the one or more EM receivers form a sequential array of receiver element rings along the longitudinal direction of the two concentric pipes, each receiver element ring in the sequential array comprising receiver elements arranged in a ring configuration adjacent to an inside surface of the inner pipe, and
wherein each pair of adjacent receiver elements in at least one receiver element ring in the sequential array is associated with one of the one or more focusing devices that is disposed between said pair of adjacent receiver elements along a circumferential direction of said at least one receiver element ring.

13. The system of claim 8,
wherein the device comprises a pipe inspection gauge (pig), and
wherein the two concentric pipes are part of a pipeline network.

14. The system of claim 8,
wherein the device is embedded in a downhole logging tool, and
wherein the two concentric pipes are part of a wellbore casing.

15. A method for measuring a wall thickness of two concentric pipes, comprising:
launching a pipe inspection gauge (pig) within an inner pipe of the two concentric pipes;
emitting, using an electromagnetic (EM) transmitter of the pig, magnetic fluxes toward one or more EM receivers of the pig;
focusing, using one or more focusing devices, the emitted magnetic fluxes to compress and guide the emitted magnetic fluxes through the inner pipe toward an outer pipe and increase a signal to noise ratio of the one or more EM receivers;
measuring, using the one or more EM receivers, the compressed and guided magnetic fluxes to generate a measured flux for providing to a pipe anomaly analyzer; and
determining, using the pipe anomaly analyzer and based on the measured flux, the wall thickness of the outer pipe of the two concentric pipes.

16. The method of claim 15,
wherein the one or more focusing devices comprise one or more of a magnet, an electrical coil, and ferromagnetic material.

17. The method of claim 15,
wherein the one or more focusing devices comprise a first focusing device disposed between the EM transmitter and the one or more EM receivers along a longitudinal direction of the two concentric pipes.

18. The method of claim 17,
wherein the one or more EM receivers comprise a sequential array of receiver element rings along the longitudinal direction of the two concentric pipes, each receiver element ring in the sequential array comprising receiver elements arranged in a ring configuration adjacent to an inside surface of the inner pipe, and
wherein each pair of adjacent receiver element rings within the sequential array is associated with one of the one or more focusing devices that is disposed between said pair of adjacent receiver element rings along the longitudinal direction of the two concentric pipes.

19. The method of claim 17,
wherein the one or more EM receivers form a sequential array of receiver element rings along the longitudinal direction of the two concentric pipes, each receiver element ring in the sequential array comprising receiver elements arranged in a ring configuration adjacent to an inside surface of the inner pipe, and
wherein each pair of adjacent receiver elements in at least one receiver element ring in the sequential array is associated with one of the one or more focusing devices that is disposed between said pair of adjacent receiver elements along a circumferential direction of said at least one receiver element ring.

20. The method of claim 15,
wherein the two concentric pipes are part of a pipeline network or part of a wellbore casing.
